(19) United States
(12) Patent Application Publication
(10) Pub. No.: US 2004/0000789 A1
(43) Pub. Date: Jan. 1, 2004

(54) Piping apparatus

(75) Inventor: Chih-Kun Chen, Taoyuan Hsien (TW)

Correspondence Address: MERCHANT & GOULD PC, P.O. BOX 2903, MINNEAPOLIS, MN, 55402-0903, US

(73) Assignee: NANYA TECHNOLOGY CORPORATION, Taoyuan (TW)

(21) Appl. No.: 10/328,061

(22) Filed: Dec. 23, 2002

(30) Foreign Application Priority Data
Jun. 27, 2002 (TW) 091209727

(51) Int. Cl. F16L 39/00

(52) U.S. Cl. 285/132.1

(57) ABSTRACT

A piping apparatus. The piping apparatus comprises a first pipe, a second pipe, and a nozzle. An end of the second pipe is disposed in the first pipe. The nozzle with a plurality of holes is connected to the end of the second pipe in the first pipe. The piping apparatus is utilized to mix an admixture to a carrier fluid. The admixture is ejected from the second pipe through the plurality of holes to the carrier fluid in the first pipe.

### BACKGROUND OF THE INVENTION

1. Field of the Invention

The present invention relates in general to a piping apparatus. In particular, the present invention relates to a nozzle which is utilized in a pipe to well mix an admixture and a carrier fluid.

2. Description of the Prior Art

Currently, when fluids are mixed in a pipe, a Y-shaped pipe is used to add an admixture to a carrier fluid. FIG. 1 shows a Y-shaped pipe. The Y-shaped pipe includes a first pipe 102 and a second pipe 104. The first pipe 102 and the second pipe 104 are interconnected and are formed as a pipe assembly.

A carrier fluid flows in the first pipe 102 along the arrow in the figure. As shown in the figure, the carrier fluid flows from left to right along the arrow. An admixture is added via the second pipe 104 to the first pipe 102. Due to the intersectional area between the first pipe 102 and the second pipe 104 is always small, the admixture and the carrier fluid are not completely mixed.

One of the solutions is to place a spiral pipe at the end of the pipe assembly. Another solution is to place some disturbing devices in the pipe assembly. The object is to increase the disturbing of the fluid in the pipe assembly. The disturbing device makes the fluid become turbulent flow, and the carrier fluid and the admixture can mix more thoroughly.

However, there is a defect that when the spiral pipe or the disturbing devices is disposed, the cost is also increased. When the carrier fluid includes suspended substances, the pipe is easy to cause an obstruction. Moreover, when the disturbing devices are larger than the pipe, the disturbing devices is not required. Therefore, the modified method of placing a spiral pipe or placing disturbing devices is not suitable in every situation.

### SUMMARY OF THE INVENTION

An object of the present invention is to provide a piping apparatus that effectively improves the problem of not well-mixing with a carrier fluid and an admixture.

Another object of the present invention is to provide a piping apparatus that can change different size of nozzle for the admixture or the size of pipe. It makes the piping apparatus of the present invention suitable in any mixing process.

Another object of the present invention is to increase the contact area between the carrier fluid and the admixture. The carrier fluid and the admixture are mixed thoroughly without additional disturbing devices.

The present invention utilizes a jet nozzle insert in a pipe, for example a cylindrical nozzle, a conical nozzle, a pyramidical nozzle, or an irregular nozzle. The shape of nozzle varies with different requirements of the pipes.

The present invention is to provide a piping apparatus, comprising a first pipe, a second pipe, and a nozzle. A carrier fluid, for example a solvent, flows in the first pipe along a direction. An end of the second pipe is disposed in the first pipe and the nozzle connects thereto. The second pipe is the inlet of a admixture. When the admixture is pouring via the second pipe to the nozzle, the carrier fluids in the first pipe siphoned off the admixture through a plurality of holes which is defined on the nozzle and proceeded the mixing process.

As mentioned above, the nozzle can be made as cylindrical, conical, pyramidical, or irregular with a plurality of holes thereon. The nozzle is not limited to the above types and the size of nozzle is changeable for different requirements of the pipes.

The plurality of holes mentioned above are evenly spaced on the nozzle. When the admixture is pouring via the second pipe, the admixture flows to the nozzle. The admixture is ejected form the second pipe through the plurality of holes to the carrier fluid in the first pipe. Therefore, the carrier fluid and the admixture can mix thoroughly.

### BRIEF DESCRIPTION OF THE DRAWINGS

The present invention can be more fully understood by reading the subsequent detailed description in conjunction with the examples and references made to the accompanying drawings, wherein:

FIG. 1 is a perspective drawing showing a Y-shaped pipe.

FIG. 2 is a perspective drawing showing a piping apparatus of the present invention;

FIG. 3a is a perspective drawing showing a type of nozzle of the present invention.

FIG. 3b is a perspective drawing showing another type of nozzle of the present invention.

FIG. 4 is a perspective drawing showing a piping apparatus of the present invention before assembling.

FIG. 5 is a perspective drawing showing a piping apparatus of the present invention after assembling.

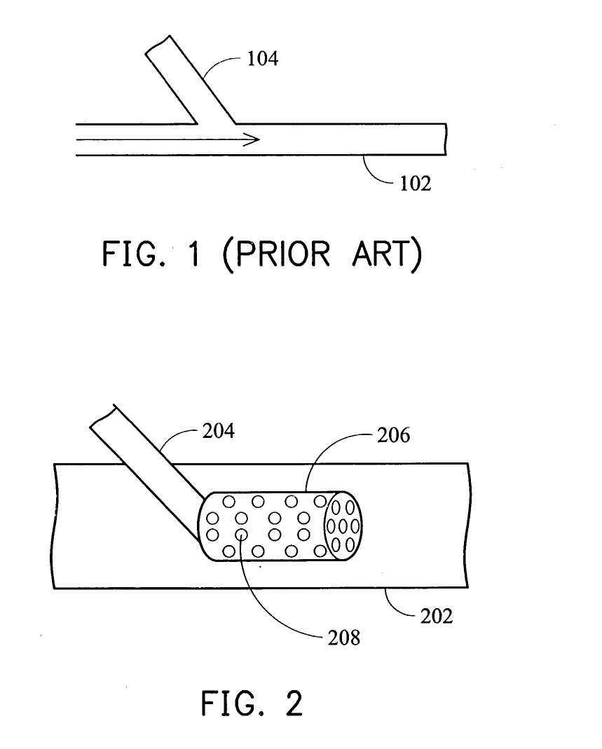

### DETAILED DESCRIPTION OF THE INVENTION

FIG. 2 is a piping apparatus of the present invention. The piping apparatus comprises a first pipe 202, a second pipe 204, a nozzle 206, and a plurality of holes 208. The first pipe 202 is a main pipe for a mixing process and a carrier fluid flows therein. The carrier fluid flows in one direction in the first pipe 202. As shown in FIG. 2, the carrier fluid flows form left to right in the first pipe 202. The second pipe 204 is an inlet of an admixture. An end of the second pipe 204 is disposed in the first pipe 202. The nozzle 206 connects to the end of the second pipe 204 in the first pipe 202. The nozzle 206 has the plurality of holes 208 thereon and the plurality of holes 208 are the outlet of the admixture.

As mentioned above, a carrier fluid, for example a solvent, flows in the first pipe 202 along a direction. When the admixture is pouring via the second pipe 204, the admixture flows to the nozzle 206. The carrier fluids in the first pipe 202 siphoned off the admixture through a plurality of holes 208 and proceeded the mixing process.

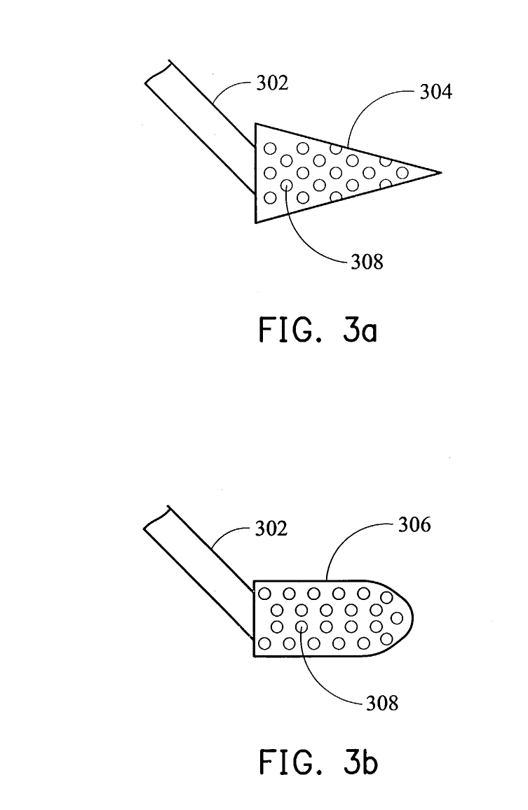

The nozzle can be made as other types. FIG. 3a and FIG. 3b shows several types of nozzles. FIG. 3a shows a pipe 302, a pyramidical nozzle 304, and a plurality of holes 308. The pipe 302 is an inlet of an admixture. The pyramidical nozzle 304 connects to an end of the pipe 302. The pyramidical nozzle 304 has the plurality of holes 308 thereon and the plurality of holes 208 are the outlet of the admixture for the mixing process. FIG. 3b shows a pipe 302, a conical nozzle 306, and a plurality of holes 308. The pipe 302 is an inlet of an admixture. The conical nozzle 306 connects to an end of the pipe 302. The conical nozzle 306 has the plurality of holes 308 thereon and the plurality of holes 208 are the outlet of the admixture for the mixing process. The nozzle is not limited to the types in FIG. 3a and FIG. 3b and the size of nozzle is changeable for different requirements of the pipes. For example, when the admixture is powder or a fluid includes suspended substances.

Moreover, the admixture in the piping apparatus of the present invention is a fluid, for example a liquid, an air, a powder, or a fluid includes suspended substances. These admixtures can well-mixing with a carrier fluid by using the piping apparatus of the present invention.

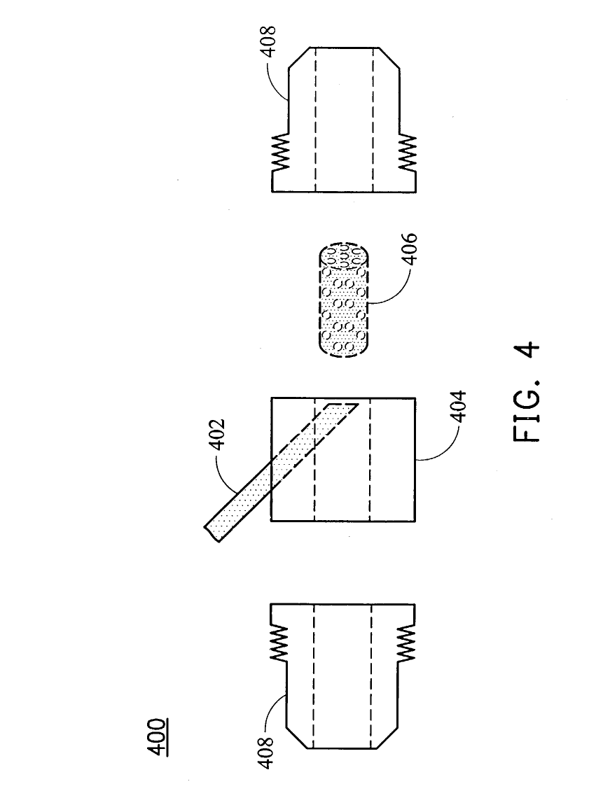

FIG. 4 is a perspective drawing showing a piping apparatus of the present invention before assembling. The piping apparatus comprises a body 400, a pipe 402, a rectangular member 404, a jet nozzle 406, and an assembly member 408.

The method of producing the body 400 is as follow: the pipe 402 is obliquely inserted into the rectangular member 404. The above intersection between the pipe 402 and the rectangular member 404 is welded together. Next step is welded the jet nozzle 406 to the pipe 402. Finally, the two ends of the rectangular member 404 are welded with the assembly member 408. the assembly member 408 is a connector.

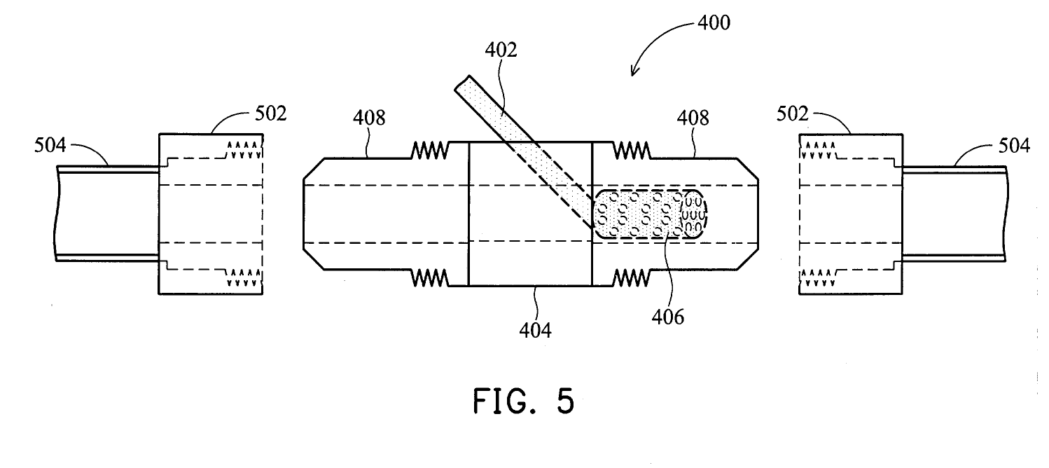

FIG. 5 is a perspective drawing showing a piping apparatus of the present invention after assembling. FIG. 5 shows a body 400, a reaming connector 502, and a main pipe 504. The body 400 utilizes the reaming connector 502 to connect to the main pipe 504. The piping apparatus of the present invention is completely assembled.

The method of producing a piping apparatus mentioned above is only an embodiment of the present invention and is not limited to the above method.

Finally, while the invention has been described by way of example and in terms of the preferred embodiments, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A piping apparatus, comprising:
a first pipe:
a second pipe, an end of which disposed in the first pipe; and
a nozzle, with a plurality of holes, connected to the end of the second pipe in the first pipe.

2. The piping apparatus as claimed in claim 1, wherein the nozzle is cylindrical.

3. The piping apparatus as claimed in claim 1, wherein the nozzle is conical.

4. The piping apparatus as claimed in claim 1, wherein the nozzle is pyramidical.

5. The piping apparatus as claimed in claim 1, wherein the plurality of holes are evenly spaced on the nozzle.
